(19) United States
(12) Patent Application Publication
(10) Pub. No.: US 2026/0227536 A1
(43) Pub. Date: Aug. 6, 2026

(54) SYSTEMS AND METHODS FOR PRODUCING UNDERWATER PRESSURE AND ACOUSTIC WAVES

(71) Applicant: General Dynamics Mission Systems, Inc., Fairfax, VA (US)

(72) Inventor: Nanthan W. Gonzales, Stoughton, MA (US)

(73) Assignee: General Dynamics Mission Systems, Inc., Fairfax, VA (US)

(21) Appl. No.: 19/045,784

(22) Filed: Feb. 5, 2025

(51) Int. Cl. G01V 1/157; G01V 1/34; H01T 1/20

(52) U.S. Cl. CPC G01V 1/157; G01V 1/345; H01T 1/20

(57) ABSTRACT

Systems and methods are provided for producing underwater pressure waves and/or acoustic waves. The systems include a spark gap and a pulsed power drive functionally coupled with the spark gap. The spark gap includes a pair of electrodes spaced apart from each other to define a gap therebetween that are configured to be submerged in water. The pulsed power drive is configured to generate a series of bursts of electrical energy and provide the bursts of electrical energy to the pair of electrodes. The series of the bursts of electrical energy produce a series of corresponding electrical arcs to form between the pair of electrodes and thereby allow current to flow through the gap while the pair of electrodes are submerged in the water. The series of the electrical arcs produces a corresponding series of pressure waves and/or acoustic waves in the water.

### TECHNICAL FIELD OF THE INVENTION

The present invention generally relates to subsea-seabed warfare and commercial activities, and more particularly relates to systems and methods for producing underwater pressure and acoustic waves.

### BACKGROUND OF THE INVENTION

This section provides background information related to the present disclosure which is not necessarily prior art.

Subsea-seabed warfare is a complex area of military operations that involves actions beneath the ocean's surface and on the seabed. This warfare focuses on controlling or disrupting subsea and seabed environments, which are critical to both economic and military stability. It includes activities such as submarine warfare, underwater mines, sabotage of seabed infrastructure (e.g., pipelines and communication cables), and anti-submarine warfare (ASW) using technologies like sonar and autonomous underwater vehicles.

As subsea-seabed warfare evolves, there is an ongoing desire for systems and methods that are capable of providing protection to various assets such as undersea energy resources, communication networks, and global shipping routes. Furthermore, other desirable features and characteristics of the present invention will become apparent from the subsequent detailed description and the appended claims, taken in conjunction with the accompanying drawings and the foregoing technical field and background.

### SUMMARY OF THE INVENTION

This section provides a general summary of the disclosure and is not a comprehensive disclosure of its full scope or all of its features.

A system is provided that, in various examples, includes a spark gap and a pulsed power drive functionally coupled with the spark gap. The spark gap includes a pair of electrodes spaced apart from each other to define a gap therebetween that are configured to be submerged in water. The pulsed power drive is configured to generate a series of bursts of electrical energy and provide the bursts of electrical energy to the pair of electrodes. The series of the bursts of electrical energy produce a series of corresponding electrical arcs to form between the pair of electrodes and thereby allow current to flow through the gap while the pair of electrodes are submerged in the water. The series of the electrical arcs produces a corresponding series of pressure waves and/or acoustic waves in the water.

A method is provided that, include various examples, includes submerging a pair of electrodes of a spark gap under water, wherein the pair of electrodes are spaced apart from each other to define a gap therebetween, generating a series of bursts of electrical energy with a pulsed power drive, and providing the series of the bursts of electrical energy to the pair of electrodes to produce a series of corresponding electrical arcs to form between the pair of electrodes and thereby allow current to flow through the gap while the pair of electrodes are submerged in the water, wherein the series of the electrical arcs produces corresponding pressure waves and/or an acoustic waves in the water.

Further areas of applicability will become apparent from the description provided herein. The description and specific examples in this summary are intended for purposes of illustration only and are not intended to limit the scope of the present disclosure.

### BRIEF DESCRIPTION OF DRAWINGS

The drawings described herein are for illustrative purposes only of selected embodiments and not all possible implementations and are not intended to limit the scope of the present disclosure.

FIG. 1 schematically represents a system for generating underwater pressure and acoustic waves in accordance with various examples;

FIG. 2 schematically represents aspects of a pulsed power drive of the system of FIG. 1 in accordance with various examples; and

FIG. 3 is a flowchart illustrating aspects of an exemplary method for generating underwater pressure and acoustic waves in accordance with various examples.

Corresponding reference numerals indicate corresponding parts throughout the several views of the drawings.

### DETAILED DESCRIPTION

Example embodiments will now be described more fully with reference to the accompanying drawings.

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

Systems and methods disclosed herein provide for controlled production of pressure waves, acoustic waves, bubbles, and other phenomenon underwater, for example, for military or commercial activities. In general, the systems and methods include generating a series of electrical arcs between submerged electrodes to generate, for example, pressure waves, acoustic waves, bubbles curtains, etc. for various applications. The systems and methods disclosed herein may be employed by, as examples, various watercraft (e.g., military or non-military ships, land-based structures adjacent to bodies of water (e.g., harbors), and water-based structures (e.g., oil rigs). The systems may or may not include an underwater tether coupled to a structure or watercraft.

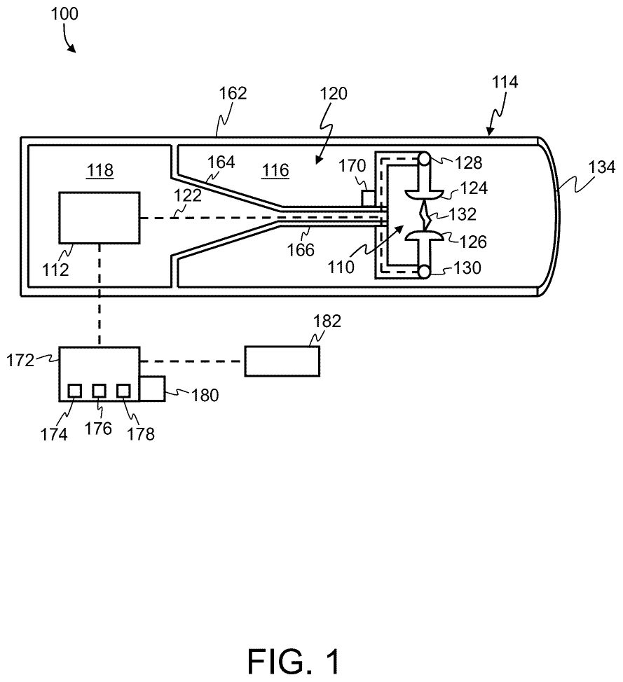

Referring initially to FIG. 1, an exemplary system 100 is represented as including a spark gap 110 and a pulsed power drive 112 electrically coupled within a housing 114. The housing 114 includes an open portion 116 and an enclosed portion 118 defined by exterior walls 162 and interior walls 164. An opening 134 is provided in the exterior walls 162 that provides fluidic access from an exterior environment to a cavity 120 within the open portion 116. The enclosed portion 118 is fluidically sealed from the cavity 120 by the interior walls 164.

The spark gap 110 includes a pair of conductive electrodes 124, 126 spaced apart from each other to define a gap therebetween. The electrodes 124, 126 are cantilevered within the cavity 120 and may be secured in various manners. In the example of FIG. 1, the electrodes 124, 126 are secured to an extension member 166 extending from the enclosed portion 118 with attachment members 128, 130. In some examples, the spark gap 110 may be configured to provide for adjustment of positions of one or both of the electrodes 124, 126 to modify a spacing or gap therebetween. For example, the gap therebetween may be referred to as having a gap dimension, and the spark gap 110 may include an adjustment device 170 configured to controllably adjust the gap dimension by moving the electrodes 124, 126 closer together or further apart. In some examples, the electrodes 124, 126 are controllably movable between a plurality of fixed positions to adjust the gap dimension. In some examples, the adjustment device 170 may include one or more actuators configured to controllably move one or both of the attachment members 128, 130.

The pulsed power drive 112 is functionally coupled with the spark gap 100 and configured to generate and provide high voltage bursts of electrical energy to the pair of electrodes 124, 126. Each of the bursts of energy provided to the electrodes 124, 126 is sufficient to cause an electrical arc 132 to form between the electrodes 124, 126 and thereby allow current to flow through the gap therebetween.

Typically, the gap between electrodes of a spark gap in a conventional device is filled with air or another gas, and an electrical discharge (i.e., a spark or electrical arc) jumps therebetween when the voltage to the electrodes exceeds a certain threshold (i.e., a breakdown voltage) and the air or gas is ionized. However, the system 100 is configured such that during operation thereof the electrodes 124, 126 are submerged in water within the cavity 120 and in fluidic communication with a body of water exterior to the opening 134. As such, the spark gap 110 is not configured to produce an electrical discharge in response to the voltage to the electrodes 124, 126 exceeding a threshold, rather the spark gap 110 is configured to produce the electrical discharge in response to receiving the burst of energy from the pulsed power drive 112. However, in some examples, a sealing conduit member (not shown) may be provided and extend between the electrodes 124, 126 that is configured to retain a gaseous environment between the electrodes 124, 126 for production of the electric arc 132 therein. In such examples, the sealing conduit member may be formed of a material that conducts the pressure waves and/or acoustic waves generated by the electric arc 132 to the water in contact with the sealing conduit member.

The pulsed power drive 112 may be configured to provide the bursts of energy at a high voltage and/or a rapid discharge rate. In some examples, the pulsed power drive 112 may be configured to provide the bursts of energy to the electrodes 124, 126 having voltages of about 50 kilovolts (kV) or greater, such as 100 kV or greater, such as 200 kV or greater. In some examples, the pulsed power drive 112 may be configured to provide the bursts of energy to the electrodes 124, 126 at a discharge rate of about one microsecond (μs) or greater, such as 100 μs or greater, such as one millisecond (ms) or greater. In some examples, the pulsed power drive 112 may be capable of relative rapid rise times and therefore configured to provide the bursts of energy to the electrodes 124, 126 at intervals (i.e., time between the bursts of energy) of about one second or less, such as between 100 μs and one second, such as less than 100 μs. In some examples, the pressure and/or acoustic waves produced by the system 100 have a sound pressure level (SPL) of about 160 dB reference (re) one μPa or greater, such as 200 dB re one μPa or greater, such as 260 dB re one μPa or greater. SPL is a logarithmic measure of the effective pressure of a sound relative to a reference value (e.g., one μPa in water).

The pulsed power drive 112 may include various devices and/or technologies capable of providing the bursts of energy. In some examples, the pulsed power drive 112 may include one or more Marx generators or banks, pulsed transformers, or a combination therein. Marx banks are devices having electrical circuits that generate a high-voltage pulse by charging a number of capacitors (a “stack” of capacitors) in parallel with a voltage supply, then rapidly connecting the stack of capacitors in series. A pulsed transformer is a high ratio transformer capable of high voltage outputs to a load utilizing energy from capacitor stores. In these examples, the resulting voltage is output from the stack of capacitors to the load. Since the charge available is limited to the charge stored on the capacitors, the output is a brief pulse or burst as the capacitors discharge through the load. Once the capacitors have been drained, the voltage supply begins charging the capacitors again (e.g., inter-pulse period).

In some examples, the pulsed power drive 112 may include one or more pulse forming networks. Pulse forming networks are devices having electrical circuits that include a series of high-voltage energy-storage capacitors and inductors or a series of pulse transformers, capacitors, and inductors. These components are interconnected as a “ladder network” that behaves similarly to a length of transmission line. Electrical energy is initially stored within the charged capacitors of the pulse forming network by a high-voltage power supply. When the pulse forming network is discharged via a high-voltage switch, the capacitors discharge in sequence, producing an approximately ringing sinusoidal pulse that decays as it is conducted to the load.

In some examples, the spark gap 110 and the pulsed power drive 112 are electrically coupled by a high voltage bus that is configured to conduct the bursts of energy therebetween. In FIG. 1, a high-voltage bus 122 is disposed within the enclosed portion 118, the extension member 166, and the attachment members 128, 130. The high-voltage bus 122, and the enclosed portion 118 in general, is electrically isolated from the cavity 120 by the interior walls 164 and/or insulation (not shown) therebetween.

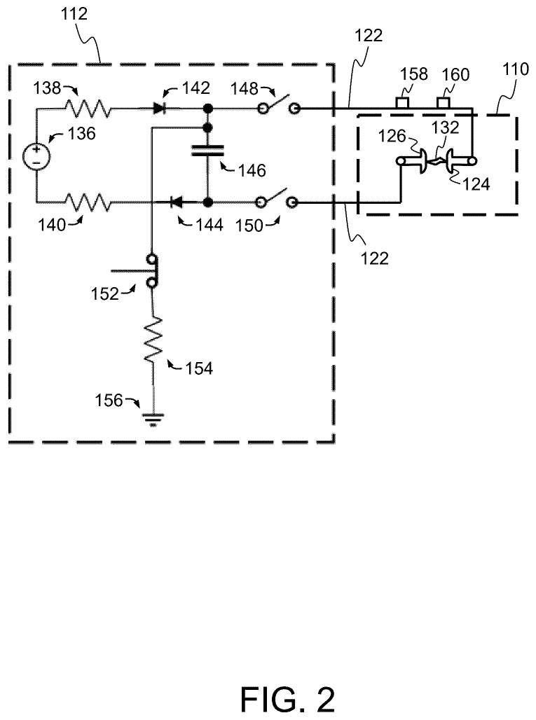

Referring now to FIG. 2, exemplary aspects of the pulsed power drive 112 are presented. In this example, the pulsed power drive 112 includes an electrical circuit having a high-voltage direct current (DC) supply electrically coupled with resistors 138, 140, diodes 142, 144, a non-polarized output capacitor 146, normally open output switches 148, normally open return switches 150, normally closed dump switch 152, a dump resistor 154, and a ground connection 156. As with the example of FIG. 1, the pulsed power drive 112 is coupled to the spark gap 110 via the high-voltage bus 122. Although the electrical circuit is represented as having only one capacitor 146 for simplicity of the description, the electrical circuit and/or the system 100 may include two or more capacitors 146, such as a plurality of capacitors 146, arranged as a “ladder network.”

FIG. 2 represents an initial position of the system 100 and prior to charging the capacitor 146 thereof. To charge the system 100, the normally closed dump switch 152 removes the connection of the capacitance to ground. Once the electrical circuit is isolated from ground, the capacitor 146 may be charged to a predetermined or desired charge voltage. Once the charge voltage has been reached, the normally open switches 148 and 150 can be closed allowing the energy to flow to the electrodes 124, 126 to produce the electric arc 132.

Referring again to FIG. 1, in some examples, the system 100 may include a controller 172, a data storage device 180, and optionally a user interface 182 for managing operation of the pulsed power drive 112 and/or other components of the system 100, such as the adjustment device 170.

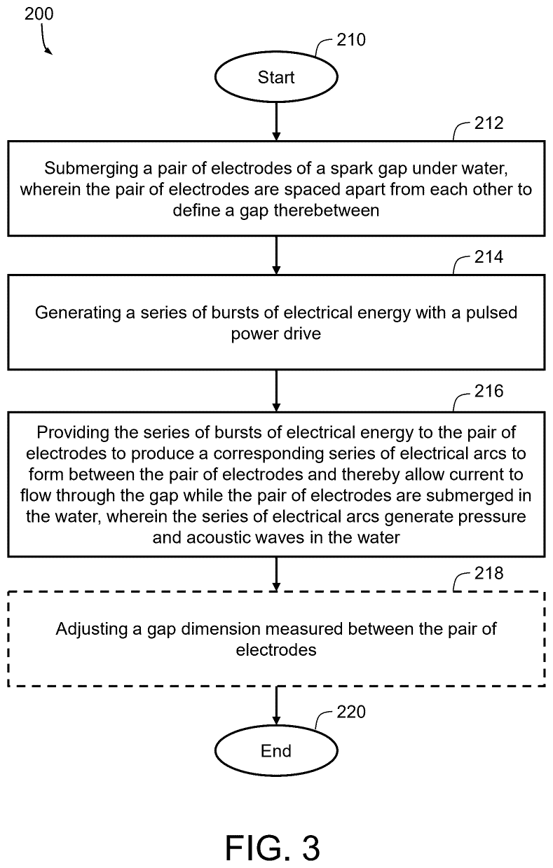

The data storage device 180 stores data for use in controlling, managing, or modifying operation the system 100 and/or systems and components thereof. As can be appreciated, the data storage device 180 may be part of the controller 172, separate from the controller 172, or part of the controller 172 and part of a separate system. The storage device 180 can be any suitable type of storage apparatus, including various different types of direct access storage and/or other memory devices. In one example, the storage device 180 comprises a program product from which a computer readable memory device can receive a program that executes one or more examples of one or more processes of the present disclosure, such as the steps of the process discussed further below in connection with FIG. 3. In another example, the program product may be directly stored in and/or otherwise accessed by the memory device and/or one or more other disks and/or other memory devices.

The controller 172 includes at least one processor 174, a computer readable storage device or media 176, and a communication bus 178. The processor 174 performs the computation and control functions of the controller 172. The processor 174 can be any custom made or commercially available processor, a central processing unit (CPU), a graphics processing unit (GPU), an auxiliary processor among several processors associated with the controller 172, a semiconductor-based microprocessor (in the form of a microchip or chip set), a macroprocessor, any combination thereof, or generally any device for executing instructions. The computer readable storage device or media 176 may include volatile and nonvolatile storage in read-only memory (ROM), random-access memory (RAM), and keep-alive memory (KAM). The computer-readable storage device or media 176 may be implemented using any of a number of known memory devices such as PROMs (programmable read-only memory), EPROMs (erasable PROM), EEPROMs (electrically erasable PROM), flash memory, or any other electric, magnetic, optical, or combination memory devices capable of storing data, some of which represent executable instructions, used by the controller 172 in controlling the system 100. The bus 178 serves to transmit programs, data, status and other information or signals between the various components of the system 100. The bus 178 can be any suitable physical or logical means of connecting computer systems and components. This includes, but is not limited to, direct hard-wired connections, fiber optics, infrared, and wireless bus technologies.

The instructions may include one or more separate programs, each of which comprises an ordered listing of executable instructions for implementing logical functions. The instructions, when executed by the processor 172, receive and process signals, perform logic, calculations, methods and/or algorithms, and generate data based on the logic, calculations, methods, and/or algorithms. Although only one controller 172 is shown in FIG. 1, examples of the system 100 can include any number of controllers 172 that communicate over any suitable communication medium or a combination of communication mediums and that cooperate to process the sensor signals, perform logic, calculations, methods, and/or algorithms, and generate data.

As can be appreciated, that the controller 172 may otherwise differ from the example depicted in FIG. 1. For example, the controller 172 may be coupled to or may otherwise utilize one or more remote computer systems and/or other control systems, for example as part of one or more of the above-identified devices and systems. It will be appreciated that while this example is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 174) to perform and execute the program. Such a program product may take a variety of forms, and the present disclosure applies equally regardless of the particular type of computer-readable signal bearing media used to carry out the distribution. Examples of signal bearing media include recordable media such as hard drives, memory cards and optical disks, and transmission media such as digital and analog communication links. It will be appreciated that cloud-based storage and/or other techniques may also be utilized in certain examples. It will similarly be appreciated that the computer system of the controller 34 may also otherwise differ from the example depicted in FIG. 1, for example in that the computer system of the controller 172 may be coupled to or may otherwise utilize one or more remote computer systems and/or other control systems.

The optional user interface 182 may include various devices configured to provide means for a user to input commands and/or receive information from the system 100. In various embodiments, the user interface 182 may include a display device (e.g., screen) and an input device (e.g., keyboard and/or pointing device). In some examples, the user interface 182 may include a touch screen display. In some examples, via various display and graphics systems processes, the controller 172 may command and control a display device or touch screen display to generate a variety of graphical user interface (GUI) objects or elements, for example, buttons, sliders, and the like, which are used to prompt a user to interact with the user interface 182 to provide user input, and to activate respective functions and provide user feedback, responsive to received user input at the GUI element.

In some examples, the system 100 may include one or more sensors configured to sense observable conditions of the environment (e.g., the body of water or the cavity 120), and/or a status or condition of a component of the system 100 and provide such condition and/or status to other systems of the system 100, such as the controller 172. It should be understood that the system 100 may include any number of the sensors. The sensors can include, but are not limited to, current sensors, voltage sensors, temperature sensors, optical cameras, thermal cameras, ultrasonic sensors, pressure sensors, articulation sensors, and/or other sensors. The sensed conditions and/or statuses may be provided to the user and/or recorded for later reference, and/or may be used by the controller 172 to provide automatic adjustment of the system 100. For example, the controller 172 may adjust, based on the sensed conditions and/or statuses, operation of the pulsed power drive 112 (e.g., timing of pulses, voltage of pulses, etc.) and/or the gap dimension between the electrodes 124, 126. In the example of FIG. 2, the system 100 includes a current sensor 158 and a voltage sensor 160 configured to sense the current and voltage, respectively, conducted to the electrode 126.

During operation, the pulsed power drive 112 may be operated to provide a series of the bursts of energy to the electrodes 124, 126 at sufficient voltage and frequency to cause a series of electrical arcs to be formed therebetween, wherein the formation of the series of electrical arcs generates pressure waves, acoustic waves, bubbles, and/or other phenomena to occur in the water within the cavity 120 and be transmitted or released to the body of water through the opening 134 for propagation within the body of water. In some examples, the shape and/or size of the cavity 120 and/or the opening 134 may be configured to promote the transmission, release, or amplification of the generated phenomena to the body of water.

One or more phenomena may be generated and transmitted or released to the body of water for various applications, including commercial and/or military operations. In some examples, pressure waves and/or acoustic waves may be generated and transmitted to the body of water by the system 100 that are configured to interfere with operation of, for example, a sonar system. In general, sonar systems emit signals that impact objects in water and return an echo to a transducer. The transducer measures the strength of the signal and the time for return to determine the object's range and orientation. The system 100 may be operated for counter sonar activities wherein a large amount of ambient noise is generated in a region of a body of water to make it difficult for a sonar system to detect a clear echo and accurately pinpoint the location and orientation of objects. In some examples, the system 100 may be configured to generate acoustic waves having frequencies, waveforms, and/or intensities within ranges common to sonar systems. In some examples, the system 100 may be configured to generate acoustic waves having a wide range of frequencies, waveforms, and/or intensities, such as bursts of energy to the electrodes 124, 126 at a discharge rate of about one ms or less, such as between about 100 μs and one ms, such as between or greater. In some examples, the pulsed power drive 112 may be capable of rise times of about one second or less, such as between 100 μs and one second. In some examples, the pressure and/or acoustic waves produced by the system 100 have a sound pressure level (SPL) of about 160 dB re 1 μPa or greater, such as 200 dB re 1 μPa or greater, such as 260 dB re 1 μPa or greater.

In some examples, bubbles may be generated and released into the body of water by the system 100 that are configured to interfere with the sonar system's ability to pinpoint a specific object through the impedance mismatch that bubbles create, such as a submarine or subsea infrastructure.

In some examples, pressure waves and/or acoustic waves may be generated and transmitted to the body of water by the system 100 that are sufficient to interfere with operation of underwater vehicles, for example, an unmanned underwater vehicle (UUV) and/or a submarine. In some examples, the system 100 may be configured to generate pressure waves and/or acoustic waves configured to interfere with sensors, sonar systems, navigation systems, targeting systems, and/or other systems of the underwater vehicles and thereby produce operational challenges that may deter the underwater vehicle from entering a region of the body of water and/or engaging in certain activities. In some examples, the pressure waves and/or acoustic waves generated and transmitted to the body of water by the system 100 may be configured to interfere with electronic devices onboard the underwater vehicle. In some examples, the pressure waves and/or acoustic waves generated and transmitted to the body of water by the system 100 may be configured to interfere with remote operation of the underwater vehicle. In some examples, bubbles may be generated and released into the body of water by the system 100 that are configured to interfere with the underwater vehicle's ability to pinpoint a specific object, such as a submarine, and target the object.

In some examples, a cloud or curtain of bubbles may be generated and released into the body of water from the system 100 that is configured to reduce noise transmittance therethrough and thereby provide noise reduction for underwater activities. For example, the system 100 may be deployed adjacent to a construction site, and as the produced bubbles rise to the surface of the body of water, the bubbles may form a relatively vertical barrier that slows down and breaks up acoustic waves passing therethrough, reducing the energy of the acoustic waves and thereby reducing noise pollution in the region. As another example, the produced bubbles may be released in a manner that reduces commercial shipping traffic noise pollution. In some examples, the produced bubbles are configured to reduce noise transmittance therethrough by at least eighty percent, such as by ninety percent or more. The bubbles may produce an impedance mismatch that is dependent on the density of the bubbles (i.e. number of bubbles in the water per unit area or volume). In some examples, the density of the bubbles, and therefore the impedance mismatch, can be adjusted or controlled based on a number of electrical arcs 114 used to produce the bubble curtain and the time intervals for when they are produced.

In some examples, pressure waves and/or acoustic waves may be generated and transmitted to the body of water by the system 100 that are configured for seismic mapping activities, such as generating detailed images of a subsurface beneath the ocean floor, revealing geological features such as faults and rock layers, identifying potential hydrocarbon reservoirs, and measuring oceanographic phenomena such as temperature and salinity variations. In some examples, the pressure waves and/or acoustic waves may be propagated from the system 100 through the body of water, echoes of the acoustic waves can be received (e.g., via hydrophones), and analysis of, for example, the travel time and amplitude of the reflected waves, may be performed. In some examples, the acoustic waves may be generated by the system 100 at low frequencies (e.g., 50 Hz to 4 kHz) capable of penetrating into the seabed for subsurface imaging.

The components of the system 100 may be formed from various materials. In some examples, one or more of the components may be chosen, at least in part, on their ability to resist adverse reactions in water (salt or fresh water) and thereby promote longevity of the system 100 while submerged in a body of water. In some examples, one or more of the components may be chosen, at least in part, on their conductivity or lack thereof. For example, the inner walls 164 may be formed of or include insulative materials to protect components disposed within the enclosed portion 118 of the housing 114. In some examples, the electrodes 124, 126 are the only components formed of electrically conductive materials that are exposed to the water within the cavity 120 of the open portion 116. In some examples the bus components 122, will be chosen for their ability to resist the water environment while still being capable of high voltage and current conduction.

The systems disclosed herein, including the system 100, provide for methods of producing pressure waves, acoustic waves, and/or bubbles in a body of water. For example, FIG. 3 is a flowchart illustrating an exemplary method 200. The method 200 may start at 210. At 212, the method 200 may include submerging a pair of electrodes of a spark gap under water. The pair of electrodes are spaced apart from each other to define a gap therebetween. At 214, the method 200 may include generating a series of bursts of energy with a pulsed power drive. At 216, the method 200 may include providing the series of bursts of energy to the pair of electrodes to produce a corresponding series of electrical arcs to form between the pair of electrodes and thereby allow current to flow through the gap while the pair of electrodes are submerged in the water. The series of electrical arcs generate pressure waves and acoustic waves in the water. At 218, the method 200 may optionally include adjusting a gap dimension measured between the pair of electrodes. In some examples, the gap dimension may be adjusted based on sensed conditions and/or statuses receive from one or more sensors. The method 200 may end at 220.

The systems and methods disclosed herein provide various benefits over certain existing systems and methods. For example, existing systems and methods for producing high sound pressure level acoustic pressure waves underwater typically require large amounts of energy and may require specially designed and built components. In contrast, use of a spark gap powered by a pulse power drive as disclosed herein provides a reliable and economic method for producing such pressure and/or acoustic waves. For military activities, the systems and methods disclosed herein may provide for non-kinetic actions for subsea-seabed warfare that may not have been previously available or practical. As used herein, non-kinetic effects refer to actions in warfare that do not use direct physical force, but instead disrupt an enemy's capabilities, communications, and/or decision-making.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A system, comprising:
a spark gap that includes a pair of electrodes spaced apart from each other to define a gap therebetween, wherein the pair of electrodes are configured to be submerged in water; and
a pulsed power drive functionally coupled with the spark gap, wherein the pulsed power drive is configured to generate a series of bursts of electrical energy and provide the bursts of electrical energy to the pair of electrodes, wherein the series of the bursts of electrical energy produce a series of corresponding electrical arcs to form between the pair of electrodes and thereby allow current to flow through the gap while the pair of electrodes are submerged in the water, wherein the series of the electrical arcs produces a corresponding series of pressure waves and/or acoustic waves in the water.

2. The system of claim 1, wherein the pulsed power drive includes a Marx bank or pulse transformers.

3. The system of claim 1, wherein the pulsed power drive includes a pulse forming network.

4. The system of claim 1, further comprising:
a housing having an enclosed portion and an open portion, wherein the open portion contains the water which is in fluidic communication with a body of water and the enclosed portion is fluidically isolated from the open portion, wherein the pair of electrodes are disposed in the open portion and the pulsed power drive is disposed in the enclosed portion; and
a high voltage bus electrically coupling the pulsed power drive to the spark gap that is configured to conduct the series of the bursts of electrical energy therebetween, wherein the high voltage bus is fluidically isolated from the water within the open portion.

5. The system of claim 1, wherein the pulsed power drive is configured to provide each of the bursts of energy to the pair of electrodes at voltages of 50 kV or greater.

6. The system of claim 1, wherein the pulsed power drive is configured to generate each of the bursts of energy at a discharge rate of one microsecond or less.

7. The system of claim 1, wherein the pulsed power drive is configured to provide the bursts of energy to the electrodes at intervals of 1 second or less.

8. The system of claim 1, wherein the pressure and/or acoustic waves have a sound pressure level (SPL) of 160 dB re 1 μPa or greater.

9. The system of claim 1, wherein the pair of electrodes are spaced apart by a gap dimension, and the system includes an adjustment device configured to controllably adjust the gap dimension.

10. A method, comprising:
submerging a pair of electrodes of a spark gap under water, wherein the pair of electrodes are spaced apart from each other to define a gap therebetween;
generating a series of bursts of electrical energy with a pulsed power drive; and
providing the series of the bursts of electrical energy to the pair of electrodes to produce a series of corresponding electrical arcs to form between the pair of electrodes and thereby allow current to flow through the gap while the pair of electrodes are submerged in the water, wherein the series of the electrical arcs produces corresponding pressure waves and/or an acoustic waves in the water.

11. The method of claim 10, wherein the pulsed power drive includes a Marx bank and pulse transformers.

12. The method of claim 10, wherein the pulsed power drive includes a pulse forming network.

13. The method of claim 10, further comprising providing a housing having an enclosed portion and an open portion, wherein the housing includes an opening providing access to the open portion, wherein the enclosed portion is fluidically isolated from the open portion, wherein the pair of electrodes are disposed in the open portion and the pulsed power drive is disposed in the enclosed portion, wherein a high voltage bus electrically couples the pulsed power drive to the spark gap and is configured to conduct the bursts of energy therebetween, wherein the high voltage bus is fluidically isolated from the water within the open portion, wherein submerging the pair of electrodes includes submerging the housing such that the water enters the open portion from the body of water.

14. The method of claim 10, wherein generating the series of the bursts of electrical energy includes operating the pulsed power drive to produce each of the bursts of electrical energy at a voltage of 50 kV or greater, and at a discharge rate of one millisecond or less, wherein providing the series of the bursts of electrical energy to the pair of electrodes includes operating the pulsed power drive to provide the bursts of energy to the pair of electrodes at intervals of one second or less.

15. The method of claim 10, wherein the pressure and/or acoustic waves have a sound pressure level (SPL) of 160 dB re one μPa or greater.

16. The method of claim 10, wherein the pair of electrodes are spaced apart by a gap dimension, and the method includes adjusting positions of one or both of the pair of electrodes to adjust the gap dimension therebetween.

17. The method of claim 10, further comprising propagating the pressure waves and/or acoustic waves produced into a body of water to interfere with operation of a sonar system.

18. The method of claim 10, further comprising propagating the pressure waves and/or acoustic waves produced into a body of water to interfere with operation of an underwater vehicle therein.

19. The method of claim 10, further comprising:
producing bubbles in the water with the secures of electrical arcs;
releasing the bubbles into a body of water to produce a curtain of the bubbles; and
providing noise reduction for underwater activities with the curtain of bubbles.

20. The method of claim 10, further comprising:
receiving reflected pressure waves and/or acoustic waves produced in response to the pressure waves and/or acoustic waves interacting with objects; and
analyzing the reflected pressure waves and/or acoustic waves for seismic mapping activities.
